(19) United States
(12) Patent Application Publication
(10) Pub. No.: US 2016/0371872 A1
(43) Pub. Date: Dec. 22, 2016

(54) SYSTEMS AND METHODS FOR PROVIDING TRANSITIONS BETWEEN CONTENT INTERFACES

(71) Applicant: Facebook, Inc., Menlo Park, CA (US)

(72) Inventors: Ling Bao, Redwood City, CA (US); Aditya Gopal Bhandarkar, San Jose, CA (US); Dharmesh A. Bhatt, East Palo Alto, CA (US); Saurabh Prafulla Chakradeo, Santa Clara, CA (US); Sophia Han Chung, Mountain View, CA (US); Kyle Philip Meyer, San Francisco, CA (US); Brandon Douglas Souba, San Francisco, CA (US); Austin Jacob Schleder, Antioch, CA (US)

(21) Appl. No.: 14/743,952

(22) Filed: Jun. 18, 2015

(51) Int. Cl. G06T 13/80; G06F 3/0481; G06F 3/0485; G06F 3/0484

(52) U.S. Cl. CPC G06T 13/80; G06F 3/0484; G06F 3/0481; G06F 3/0485; G06T 2200/24

(57) ABSTRACT

Systems, methods, and non-transitory computer-readable media can present a first interface that provides a first set of content items. A command to present a second interface that provides a second set of content items can be detected. An animation that transitions from the first interface to the second interface can be performed. The animation can cause a second subset of content items out of the second set to be visually representative of a first subset of content items out of the first set.

### FIELD OF THE INVENTION

The present technology relates to the field of providing content. More particularly, the present technology relates to techniques for providing transitions between content interfaces.

### BACKGROUND

Today, people often utilize computing devices (or systems) for a wide variety of purposes. Users can use their computing devices, for example, to interact with one another, access content, share content, and create content. In some cases, users can utilize their computing devices to view, interact with, or otherwise access content (or resources). In one example, a user of a social networking system (or service) can utilize his or her computing device to access web content, such as profiles, pages, events, and groups, via the social networking system.

Under conventional approaches, the user generally has to perform a significant number of commands or interactions in order to browse through various interfaces for presenting content, such as profiles, pages, events, and groups. Conventional approaches can create friction or a lack of fluidity in the user experience when browsing through such interfaces and content. Moreover, in accordance with conventional approaches, the display space on the user's computing device may be limited, and thus performing a significant number of commands or interactions can be inconvenient or difficult for the user. Furthermore, conventional approaches to providing access to content via interfaces can often times be boring, static, or lacking in interactivity. As such, conventional approaches can create challenges for or reduce the overall user experience associated with providing and accessing content via interfaces.

### SUMMARY

Various embodiments of the present disclosure can include systems, methods, and non-transitory computer readable media configured to present a first interface that provides a first set of content items. A command to present a second interface that provides a second set of content items can be detected. An animation that transitions from the first interface to the second interface can be performed. The animation can cause a second subset of content items out of the second set to be visually representative of a first subset of content items out of the first set.

In an embodiment, a trigger to load information associated with the second interface can be detected subsequent to presenting the first interface. A loading of the information associated with the second interface can be initiated prior to detecting the command to present the second interface. The second interface that provides the second set of content items can be constructed prior to performing the animation. The second interface can be constructed based on the information.

In an embodiment, the trigger can occur when a specified minimum amount of time has elapsed while the first interface is presented.

In an embodiment, at least some content items in the second set can be provided based on the information.

In an embodiment, at least some content items in the second subset can be provided based on at least some content items in the first subset.

In an embodiment, the at least some content items in the first subset can include at least one of a profile image, a cover image, or an entity identifier.

In an embodiment, access to at least a third interface, adjacent to the first interface along a first axis, can be provided. The second interface can be accessible from the first interface via a second axis.

In an embodiment, the first axis can include a horizontal axis and the second axis can include a vertical axis. Access to at least the third interface can be provided based on a first scroll command performed with respect to the horizontal axis. The command to present the second interface can include a second scroll command performed with respect to the vertical axis.

In an embodiment, each of the first scroll command and the second scroll command can be associated with at least one of a mouse click operation, a mouse drag operation, a mouse hover operation, a tapping touch gesture, a holding touch gesture, or a swiping touch gesture.

In an embodiment, the animation can cause a first planar size of the first interface to be visually matched, within an allowable deviation, with a second planar size of the second interface. The animation can include cross-fading between the first interface and the second interface. The animation can include scrolling from the first interface to the second interface at a smooth scrolling pace.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example interface transition module configured to facilitate providing transitions between content interfaces, according to an embodiment of the present disclosure.

FIG. 2A illustrates an example interface presentation module configured to facilitate providing transitions between content interfaces, according to an embodiment of the present disclosure.

FIG. 2B illustrates an example detection module configured to facilitate providing transitions between content interfaces, according to an embodiment of the present disclosure.

FIG. 2C illustrates an example transitional animation module configured to facilitate providing transitions between content interfaces, according to an embodiment of the present disclosure.

FIG. 3 illustrates an example scenario associated with providing transitions between content interfaces, according to an embodiment of the present disclosure.

FIG. 4 illustrates an example scenario associated with providing transitions between content interfaces, according to an embodiment of the present disclosure.

FIG. 5 illustrates an example scenario associated with providing transitions between content interfaces, according to an embodiment of the present disclosure.

FIG. 6A illustrates an example method associated with providing transitions between content interfaces, according to an embodiment of the present disclosure.

FIG. 6B illustrates an example method associated with providing transitions between content interfaces, according to an embodiment of the present disclosure.

FIG. 7 illustrates a network diagram of an example system including an example social networking system that can be utilized in various scenarios, according to an embodiment of the present disclosure.

FIG. 8 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Providing Transitions Between Content Interfaces

People use computing devices (or systems) for various purposes. Computing devices can provide different kinds of functionality. Users can utilize their computing devices to produce content, such as by writing articles, taking pictures, or recording videos. Users can also use their computing devices to consume content, such as by reading articles, viewing media, or accessing web resources (e.g., web sites, online services, etc.). In some cases, users of a social networking system (or service) can use their computing devices to communicate or interact with other users as well as to create content, provide content, share content, and/or access content, via the social networking system.

Under conventional approaches, various resources or content items can be provided via interfaces. In one example, in order to access a particular content item within the social networking system, a user may have to navigate to a first interface. In this example, when the user desires to access another content item, the user may have to perform a significant number of operations or interactions to exit, close, or cancel the first interface and then open or run a second interface to access the other content item. Accordingly, such conventional approaches can cause friction in or can reduce the fluidity of the user experience associated with accessing content items. Moreover, the computing device of the user may have a small display screen, such that it can be cumbersome or inconvenient for the user to perform a significant number of such operations or interactions, in accordance with conventional approaches. Additionally, conventional approaches to providing interfaces for accessing content can often times be uninteresting, dull, or lacking in interactivity.

Due to these or other concerns, conventional approaches can be inconvenient, inefficient, or challenging. Therefore, an improved approach can be beneficial for addressing or alleviating various drawbacks associated with conventional approaches. The disclosed technology can provide transitions between content interfaces. Various embodiments of the present disclosure can present a first interface that provides a first set of content items. A command to present a second interface that provides a second set of content items can be detected. An animation that transitions from the first interface to the second interface can be performed. The animation can cause a second subset of content items out of the second set to be visually representative of a first subset of content items out of the first set. It is contemplated that there can be many variations and/or other possibilities.

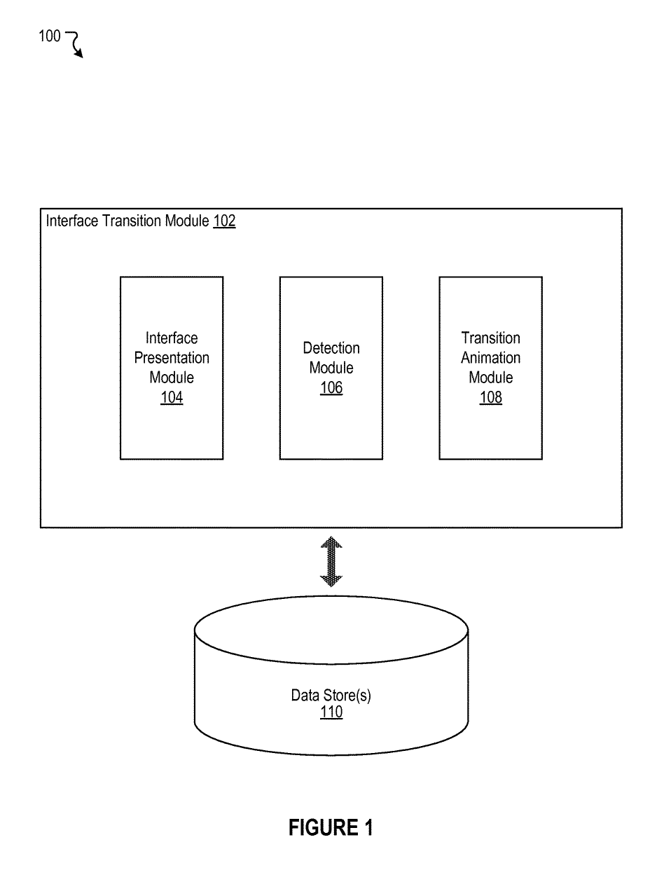

FIG. 1 illustrates an example system 100 including an example interface transition module 102 configured to facilitate identifying illegitimate accounts based on clustering, according to an embodiment of the present disclosure. As shown in the example of FIG. 1, the interface transition module 102 can include an interface presentation module 104, a detection module 106, and a transition animation module 108. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details.

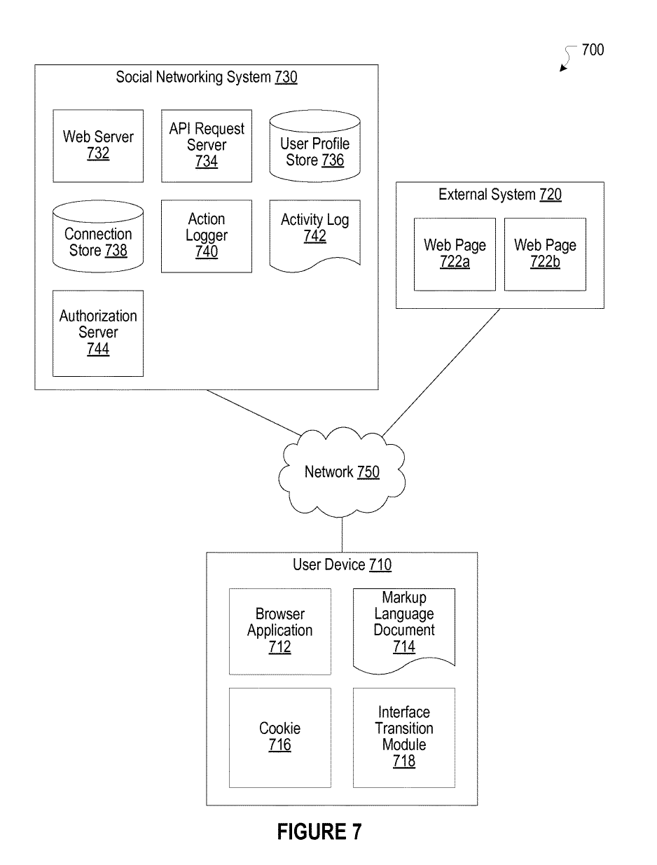

In some embodiments, the interface transition module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the interface transition module 102 can be implemented, in part or in whole, as software running on one or more computing devices or systems, such as on a user or client computing device. For example, the interface transition module 102 or at least a portion thereof can be implemented as or within an application (e.g., app), a program, or an applet, etc., running on a user computing device or a client computing system, such as the user device 710 of FIG. 7. In another example, the interface transition module 102 or at least a portion thereof can be implemented using one or more computing devices or systems that include one or more servers, such as network servers or cloud servers. In some instances, the interface transition module 102 can, in part or in whole, be implemented within or configured to operate in conjunction with a social networking system (or service), such as the social networking system 730 of FIG. 7. It should be understood that there can be many variations or other possibilities.

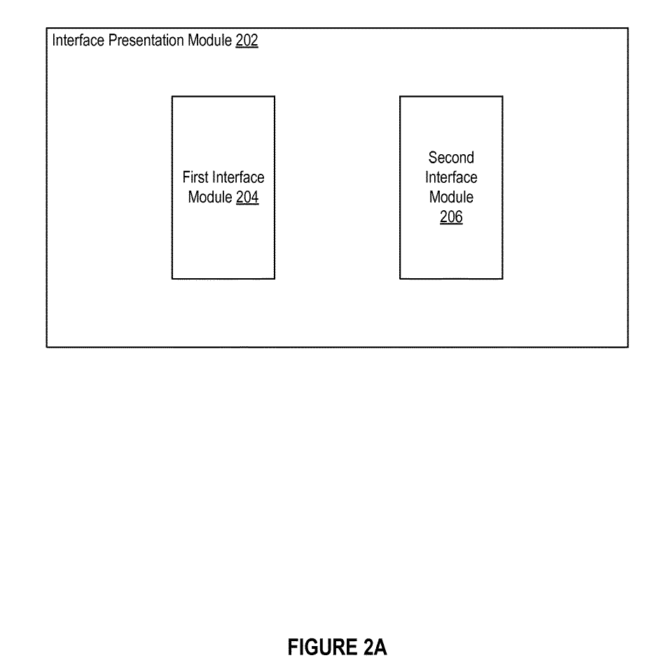

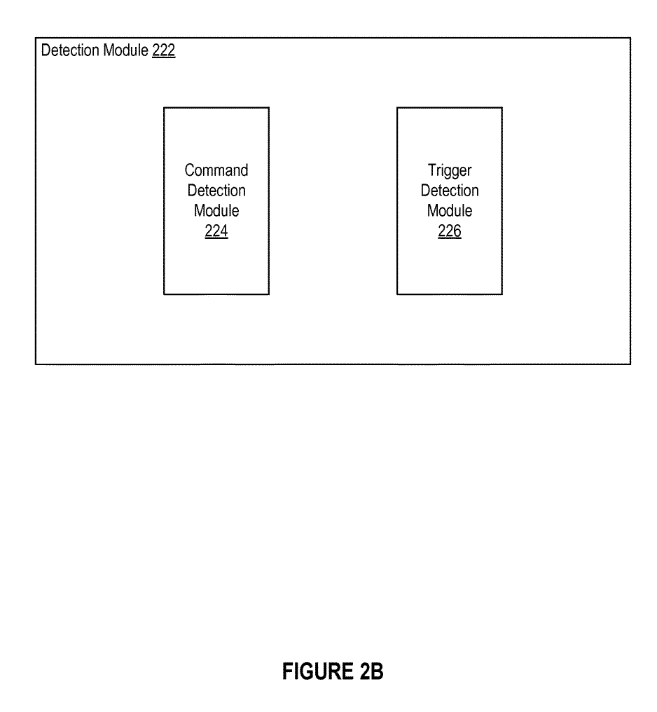

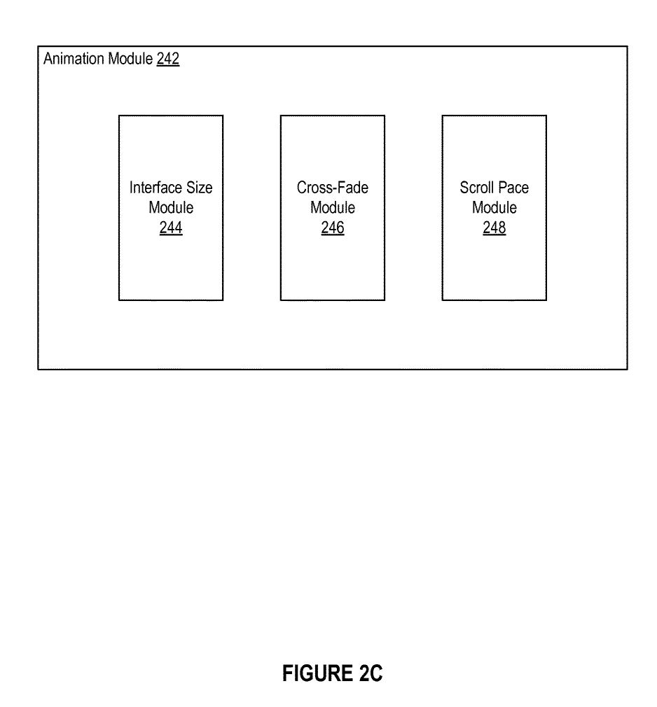

The interface presentation module 104 can be configured to facilitate presenting a first interface that provides a first set of content items. In some cases, the first interface can correspond to a virtual entity card or a virtual card that provides information or content associated with an entity. For example, in the context of the social networking system, the interface presentation module 104 can display, to a user of the social networking system, an initial interface that provides access to limited information associated with a profile (i.e., timeline, wall, etc.) of an entity (e.g., another user), a page of another entity (e.g., a public figure, a business, a brand, etc.), an event (e.g., a gathering), and/or a group (e.g., a collection of one or more entities). In this example, the first set of content items can indicate some basic information associated with the entity, group, or event, such as an identifier, a profile image, a cover image, a number of social connections or friends, and/or various links, etc. More details regarding the interface presentation module 104 will be provided below with reference to FIG. 2A.

In addition, the detection module 106 can be configured to facilitate detecting a command to present a second interface that provides a second set of content items. For instance, the second interface providing the second set of content items can correspond to a subsequent interface presenting an entity profile (i.e., timeline, wall, etc.) that provides more information associated with the entity, such as posts (e.g., stories, media, communications, etc.) directed to the entity, posts made from the entity, and/or other additional content or information about the entity. The second of content items can also provide basic information, such as an identifier, a profile image, a cover image, a number of social connections or friends, and/or various links associated with the entity. In another instance, the second interface providing the second set of content items can correspond to a page of an entity, group, or event. In this instance, the second set of content items can provide detailed information or content, such as posts made to and from the entity, group, or event, as well as basic information, such as identifiers, profile images, cover images, etc. The detection module 106 will be discussed in more detail with reference to FIG. 2B.

Moreover, the transition animation module 108 can be configured to facilitate performing an animation that transitions from the first interface to the second interface. The animation can cause a second subset of content items out of the second set to be visually representative of a first subset of content items out of the first set. In some cases, the transition animation module 108 can cause the second subset of content items to be visually representative of the first subset by causing content items in the second subset to appear visually the same as, similar to, aligned with, and/or matched with content items in the first subset. More details regarding the legitimacy module will be provided below with reference to FIG. 2C.

Furthermore, in some embodiments, the interface transition module 102 can be configured to communicate and/or operate with the at least one data store 110, as shown in the example system 100. The at least one data store 110 can be configured to store and maintain various types of data. In some implementations, the at least one data store 110 can store information associated with the social networking system (e.g., the social networking system 730 of FIG. 7). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 110 can store information associated with users, such as user identifiers, user information, profile information, user locations, user specified settings, content produced or posted by users, and various other types of user data. In some embodiments, the at least one data store 110 can store information that is utilized by the interface transition module 102, such as by caching various content items or other information presentable via interfaces. It is contemplated that there can be many variations or other possibilities.

FIG. 2A illustrates an example interface presentation module 202 configured to facilitate providing transitions between content interfaces, according to an embodiment of the present disclosure. In some embodiments, the interface presentation module 104 of FIG. 1 can be implemented as the example interface presentation module 202. As shown in FIG. 2A, the interface presentation module 202 can include a first interface module 204 and a second interface module 206.

As discussed previously, the interface presentation module 202 can facilitate generating, developing, and/or presenting a first interface that provides a first set of content items. In some embodiments, the interface presentation module 202 can utilize the first interface module 204 to present the first interface that provides the first set of content items. The first interface module 204 can, in some cases, present the first interface as an initial interface that provides access to certain information associated with an entity. In one example, the first interface can be associated with a virtual entity card that provides access to basic information about an entity. In this example, the basic information can be associated with the first set of content items, which can include (but is not limited to) an identifier for the entity, a profile image for the entity, and/or a cover image for the entity, etc. It should be appreciated that many variations are possible.

In one example, a user of a social networking system can utilize the first interface to access the first set of content items, which can be associated with an entity (e.g., another user of the social networking system). In this example, the user can use the first interface to view basic information associated with the entity. In this example, the entity can correspond to another user that the social networking system has suggested for the user to add as a social connection or friend. If the user so desires, he or she can elect to access a second interface that provides additional information about the entity, such as via a second set of content items.

In some implementations, the interface presentation module 202 can utilize the second interface module 206 to generate, develop, and/or present the second interface that provides the second set of content items. In some cases, the second interface can be related to the first interface in that the first interface can initially provide limited or basic information associated with the entity while the second interface can subsequently provide additional or more detailed information associated with the entity. In one instance, the second interface module 206 can cause the second interface to correspond to a subsequent interface presenting an entity profile (i.e., timeline, wall, etc.) that provides access to posts (e.g., stories, media, communications, etc.) directed to the entity, posts made by the entity, and/or other additional content or information about the entity. Like the first interface, the second interface can also provide basic information, such as an identifier for the entity, a profile image of the entity, a cover image of the entity, a number of social connections or friends/followers/members the entity has, and/or various links associated with the entity. In another instance, the second interface can be associated with a page of an entity, group, or event. In this instance, the second set of content items can provide detailed information or content, such as posts made to and from the entity, group, or event, as well as basic information, such as identifiers, profile images, cover images, etc. Many variations are possible.

Furthermore, in some embodiments, the interface presentation module 202 can facilitate providing access to at least a third interface adjacent to the first interface along a first axis. The interface presentation module 202 can also cause the second interface to be accessible from the first interface via a second axis. In some cases, the third interface can correspond to an initial interface that provides limited information associated with another entity. Additional information associated with the other entity can be provided via a fourth interface, which can be accessible from the third interface along the second axis. Accordingly, there can be numerous interfaces for multiple entities.

In one example, a user who is attempting to access (or view) information about a set of entities can begin at a first interface that provides limited information about a first entity. If the user desires to access additional information about the first entity, the user can access a second interface by swiping or scrolling vertically (e.g., swiping up, dragging up, scrolling down, etc.) from the first interface. In this example, when accessing the second interface, the user can also return to the first interface by swiping or scrolling vertically from the second interface in an opposite direction (e.g., swiping down, dragging down, scrolling up, etc.). Moreover, while at the first interface, if the user desires to access information about a second entity, then the user can swipe or scroll horizontally (e.g., swipe left/right, drag left/right, scroll right/left, etc.) from the first interface in order to access a third interface that provides limited information about the second entity. In this example, the user can swipe or scroll vertically from the third interface to access a fourth interface that provides additional information about the second entity. Furthermore, when at the third interface, the user can swipe or scroll horizontally from the third interface to return to the first interface or to access a fifth interface that provides limited information about a third entity, and so forth. It is contemplated that all examples herein are provided for illustrative purposes. It should be understood that there can be many variations or other possibilities associated with the disclosed technology.

FIG. 2B illustrates an example detection module 222 configured to facilitate providing transitions between content interfaces, according to an embodiment of the present disclosure. In some embodiments, the detection module 106 of FIG. 1 can be implemented as the example detection module 222. As shown in FIG. 2B, the detection module 222 can include a command detection module 224 and a trigger detection module 226.

As discussed above, the detection module 222 can facilitate detecting a command to present a second interface that provides a second set of content items. In some implementations, the detection module 222 can utilize the command detection module 224 to detect the command to present the second interface that provides the second set of content items. Moreover, in some embodiments, the command detection module 224 can also detect another command that causes access to at least a third interface to be provided. As discussed previously, at least the third interface can be adjacent to the first interface along a first axis. At least the third interface can be accessible from the first interface via the first axis, while the second interface can be accessible from the first interface via a second axis. For instance, the first axis can include a horizontal axis and the second axis can include a vertical axis. In some cases, access to at least the third interface can be provided based on a first scroll command performed with respect to the horizontal axis, and the command to present the second interface can include a second scroll command performed with respect to the vertical axis.

In some embodiments, each of the commands can be defined or specified to correspond to a touch gesture (e.g., swipe, flick, tap, press, hold, etc.), a mouse operation (e.g., click, drag, hover, etc.), a scroll operation, a button press, or a switch flip, etc. For instance, the first scroll command can be predefined, preconfigured, or preset to correspond to a touch gesture horizontal swipe (or a left/right scroll operation) and the second scroll command can be predefined, preconfigured, or preset to correspond to a touch gesture vertical swipe (or an up/down scroll operation). In one example, the command detection module 224 can utilize a touch display (or other touch sensor) of a user's computing device to detect a first scroll command (for accessing at least the third interface) when the user performs a touch gesture horizontal swipe with respect to the first interface displayed on the touch display. Moreover, in this example, the command detection module 224 can utilize the touch display to detect a second scroll command (for accessing the second interface) when the user performs a touch gesture swipe up (or a scroll down operation) with respect to the first interface displayed on the touch display. In some cases, the user can also return to a previous interface when he or she performs a touch gesture swipe in an opposite direction. It should be understood that many variations are possible.

Additionally, in some implementations, the trigger detection module 226 can be configured to facilitate detecting, subsequent to presenting the first interface, a trigger to load information associated with the second interface that provides the second set of content items. When the trigger is detected, a loading of the information associated with the second interface can be initiated. The loading of the information can be initiated prior to detecting the command to present the second interface that provides the second set of content items. The second interface that provides the second set of content items can be constructed based on the information. For instance, at least some content items in the second set can be provided based on the information. The second interface can be constructed prior to performing the animation that transitions from the first interface to the second interface.

In some embodiments, the trigger can occur, and can be detected by the trigger detection module 226, when a specified minimum amount of time has elapsed while the first interface is presented. In one example, the specified minimum amount of time can correspond to 250 milliseconds. It is contemplated that any suitable amount of time can be used. However, in some cases, if the user attempts to access at least the third interface, then the loading of the information associated with the second interface can be ceased or canceled. Again, there can be many variations or other possibilities. For example, other triggers such as those based on eye tracking, head movement, likelihood of interest, and/or likelihood of scrolling, etc., can be utilized with the disclosed technology.

FIG. 2C illustrates an example transitional animation module 242 configured to facilitate providing transitions between content interfaces, according to an embodiment of the present disclosure. In some embodiments, the transitional animation module 108 of FIG. 1 can be implemented as the example transitional animation module 242. As shown in FIG. 2C, the transitional animation module 242 can include an interface size module 244, a cross-fade module 246, and a scroll pace module 248.

As discussed, the transitional animation module 242 can be configured to facilitate performing an animation that transitions from a first interface to a second interface. In some instances, at least a portion of the animation can occur while the command to present the second interface is being performed by a user. Also, the animation can cause a second subset of content items out of the second set to be visually representative of (e.g., matched in size/appearance to, aligned in size/appearance to, substantially equivalent in size/appearance to, etc.) a first subset of content items out of the first set. This can increase the visual smoothness and fluidity of the transition from the first interface to the second interface.

In some implementations, the transitional animation module 242 can utilize the interface size module 244 to facilitate performing the animation such that the animation causes a first planar size of the first interface to be visually matched, within an allowable deviation, with a second planar size of the second interface. The transitional animation module 242 can utilize the cross-fade module 246 to facilitate performing the animation such that the animation includes cross-fading between the first interface and the second interface. Moreover, the transitional animation module 242 can utilize the scroll pace module 248 to facilitate performing the animation such that the animation includes scrolling from the first interface to the second interface at a smooth scrolling pace.

In one example, during the animation, the interface size module 244 can cause the first interface to expand in planar size from an initial first interface size to a final first interface size (e.g., the first planar size). The interface size module 244 can also cause an initial size of the second interface (i.e., an initial second interface size, the second planar size) to be same as (i.e., within an allowable deviation of being the same as, substantially similar to, etc.) the final first interface size. Continuing with the animation, the cross-fade module 246 can cross-fade from the first interface in (or near) the final first interface size to the second interface in (or near) the initial second interface size. For the rest of the animation, the interface size module 244 can then expand the second interface from the initial second interface size to the final second interface size.

In some implementations, the scroll pace module 248 can determine a pace associated with the command from the user to present the second interface. In some cases, during the animation, the scroll pace module 248 can cause the pace associated with the command to affect how the first interface and/or the second interface are scrolled. In some instances, subsequent to the animation, the scroll pace module 248 can cause the pace associated with the command to be continued with respect to the second interface such that the second interface continues to scroll, at least temporarily, based on the pace. In one example, if the user performs a significant swipe up gesture with respect to the first interface, the animation can transition the first interface to the second interface and the second interface can continue to scroll down based on the velocity, acceleration, and/or length of the user's swipe up gesture.

Additionally, in some embodiments, the animation can be performed using a main or primary thread of a computing device in attempt to ensure smoothness and fluidity. Information associated with the second interface can be stored in the background in a cache. In some cases, the cache can provide the information associated with the second interface, via a thread other than the main or primary thread, subsequent to the initiation (and/or completion) of the animation. It should be appreciated that there can be many variations or other possibilities.

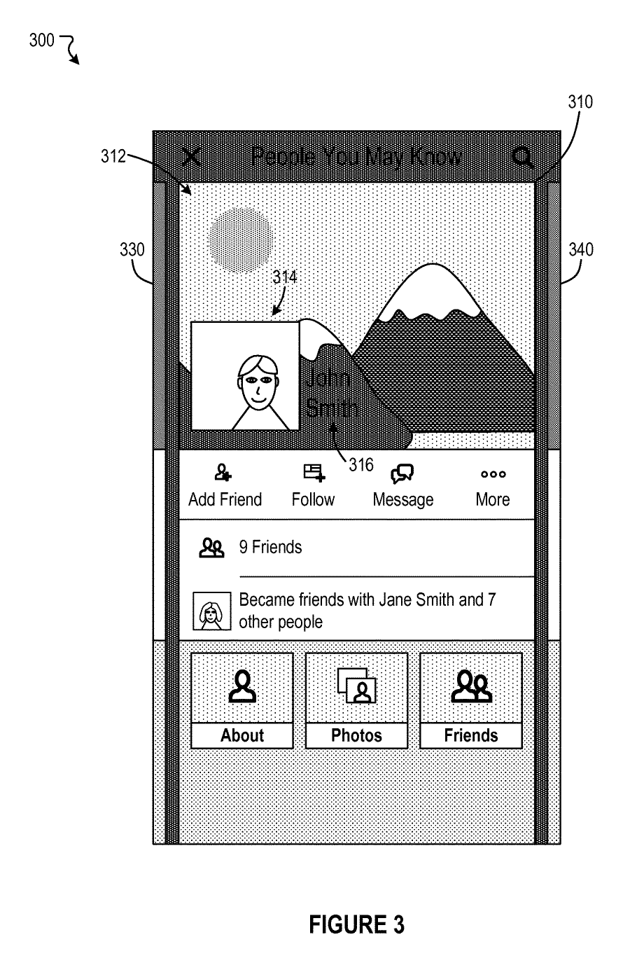

FIG. 3 illustrates an example scenario 300 associated with providing transitions between content interfaces, according to an embodiment of the present disclosure. As shown, the example scenario 300 illustrates a screenshot of a computing device (or system) of a user who is capable of accessing (or viewing, interacting with, etc.) information associated with an entity, a page, a group, or an event, etc., within a social networking system.

In the example scenario 300, the user is viewing a profile of a particular entity (“John Smith”) out of a set of entities suggested or recommended by the social networking system. In this example, the entities can be determined by the social networking system to correspond to people that the user may know or recognize. As shown, the user is accessing a first interface 310 that provides a first set of content items associated with the particular entity “John Smith”. For instance, the first interface 310 provides access to the particular entity's cover photo 312, profile picture 314, name 316, social data (e.g., number of friends, social activity log, etc.), and various links/options/buttons (e.g., add friend, follow, message, about, photos, friends, etc.).

In some cases, if the user desires to view additional information or content about the particular entity “John Smith”, the user can swipe up (or scroll down) with respect to the first interface to cause a second interface to be presented. The second interface can provide additional information via a second set of content items.

Moreover, if the user desires to view profiles of other entities, then the user can swipe left or right with respect to the first interface. In the example scenario 300, another interface 330 for another entity's profile can be presented if the user swipes rightward from the first interface 310, and yet another interface 340 for yet another entity's profile can be presented if the user swipes leftward from the first interface 310. The user can swipe further left or right to access interfaces for different entities in the set of entities. It is contemplated that many variations are possible.

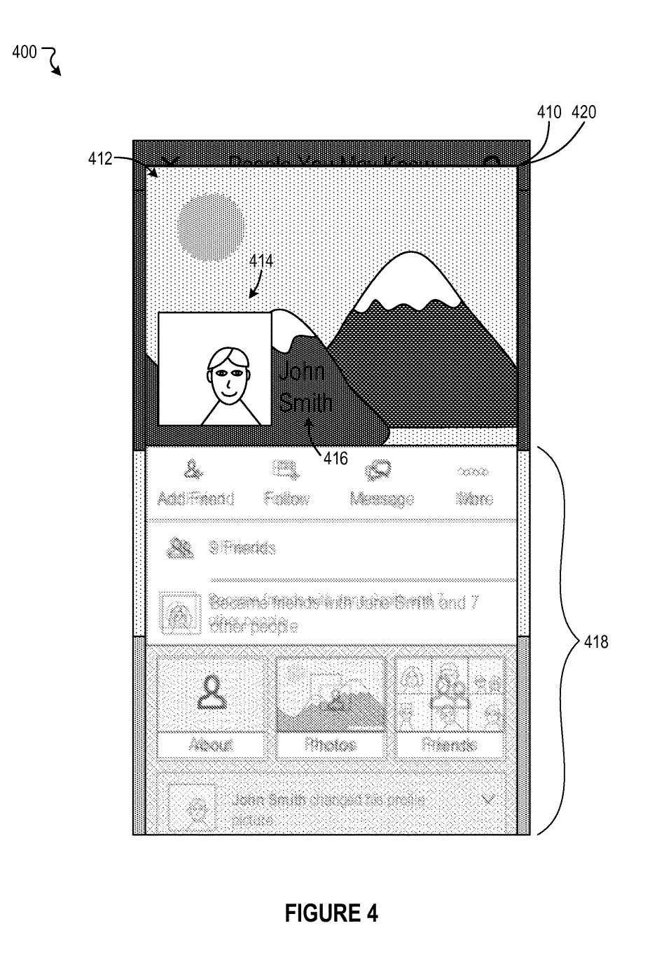

FIG. 4 illustrates an example scenario 400 associated with providing transitions between content interfaces, according to an embodiment of the present disclosure. The example scenario 400 can involve a command performed with respect to the example scenario 300 of FIG. 3. In the example scenario 400 of FIG. 4, an animation can transition a first interface 410 (e.g., the first interface 310) to a second interface 420. As shown in FIG. 4, the first interface 410 can appear to overlay the second interface 420.

In some embodiments, the animation can cause the first interface 410 to expand from an initial size (as shown with the first interface 310 in the example scenario 300) to a final size. Furthermore, the animation can cause the second interface 420 to start at an initial size corresponding to the final size of the first interface 410. The animation can also cause the second interface 420 to expand from its initial size to a final size. The animation can further cause a second subset of content items out of a second set of content items provided by the second interface 420 to be visually representative of a first subset of content items out of a first set of content items provided by the first interface 410. In this example, the cover photo 412, profile picture 414, and name 416 can all be visually aligned, matched, maintained in appearance, and/or synchronized, etc., within an allowable deviation, during the animation transitioning the first interface 410 to the second interface 420. For instance, the first and second subsets of content items can expand and/or shrink in substantially the same manner while transitioning between the first interface 410 and the second interface 420. This can provide a smooth or fluid user experience.

Moreover, the animation can also include cross-fading between the first interface 410 in (or near) its final size and the second interface 420 in (or near) its initial size. In some implementations, the cross-fading can be performed with respect to the entireties of the first interface 410 and the second interface 420. In some cases, since the first and second subsets of content items are visually representative of each other, the cross-fading may not affect their appearance. Instead, one or more other portions 418 of the first interface 410 and the second interface 420 can be affected by the cross-fading. For instance, the cross-fading can result in changes to various text and/or icons, which can indicate or suggest to the user that new content or information is available.

Furthermore, in some embodiments, the text size (e.g., font size) in the one or more other portions 418 are maintained, within an allowable deviation, from the first interface 410 to the second interface 420. Additionally, in some implementations, in order to increase efficiency and/or to improve performance, at least some content items in the second subset can be provided based on at least some content items in the first subset. For instance, since the first subset of content items (e.g., a header including the cover photo 412, the profile picture 414, and the name 416, etc.) of the first interface 410 has already been loaded, the second interface 420 can utilize the first subset as the second subset. As discussed, many variations are possible.

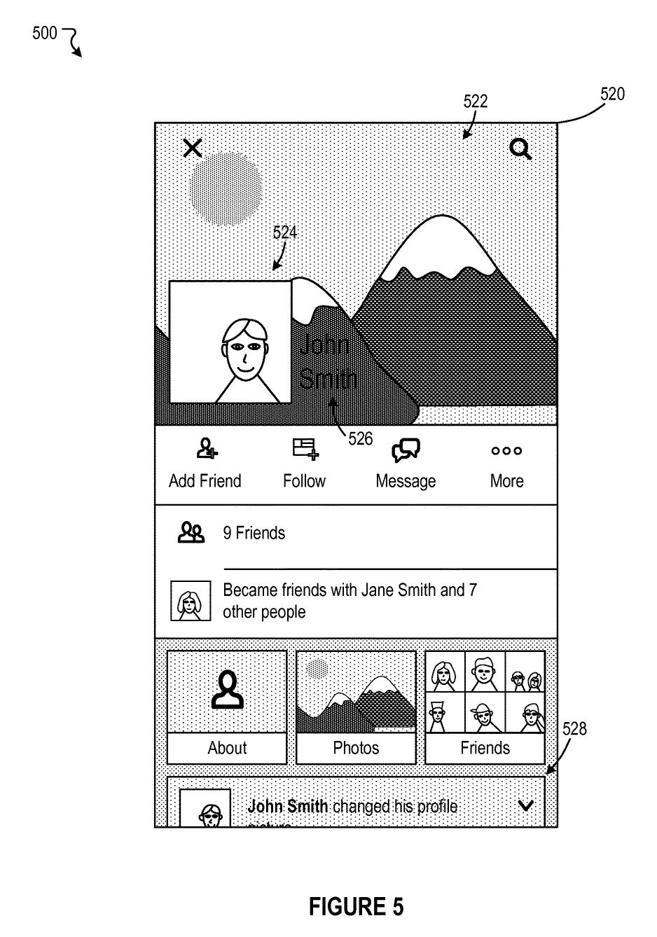

FIG. 5 illustrates an example scenario 500 associated with providing transitions between content interfaces, according to an embodiment of the present disclosure. The example scenario 500 can illustrate the example scenario 400 of FIG. 4 subsequent to an animation that transitions from a first interface to a second interface 520. In the example scenario 500 of FIG. 5, the second interface 520 providing a second set of content items is shown.

In some cases, the second set of content items can include a cover photo 522, a profile picture 524, a name 526, social data (e.g., number of friends, social activity log, etc.), and various links/options/buttons (e.g., add friend, follow, message, about, photos, friends, etc.) associated with a particular entity “John Smith”. Moreover, the second set can include a feed or timeline 528 including one or more posts associated with the particular entity “John Smith”. As discussed previously, the second interface 520 can be provided in response to a command that causes an animation to transition the first interface to the second interface 520. Again, it should be understood that all examples herein are provided for illustrative purposes and that many variations are possible.

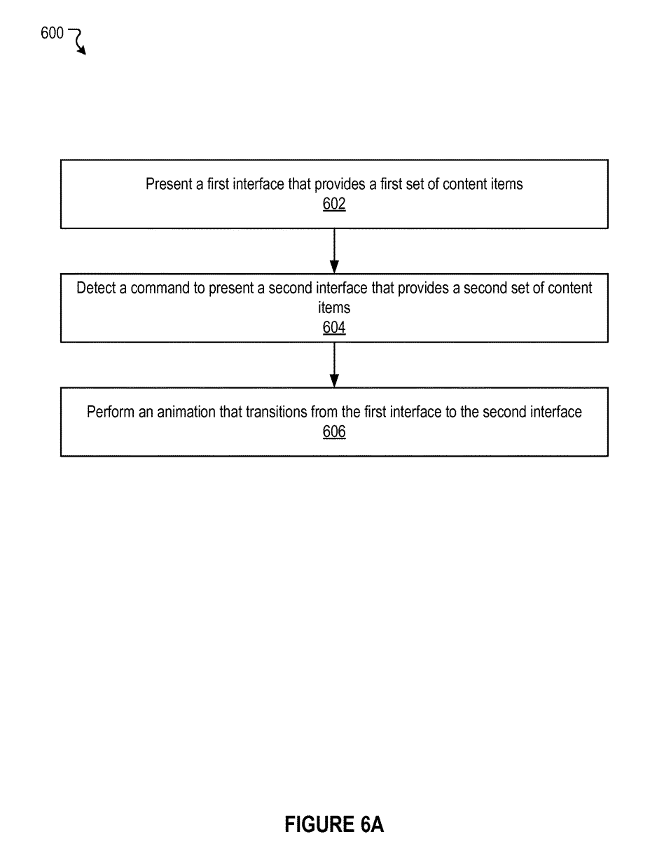

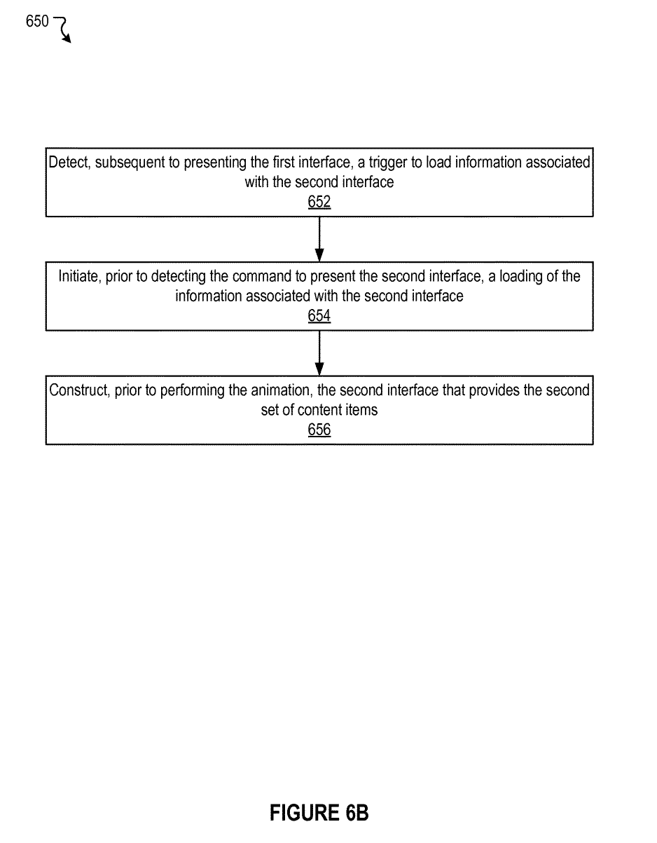

FIG. 6A illustrates an example method 600 associated with providing transitions between content interfaces, according to an embodiment of the present disclosure. It should be appreciated that there can be additional, fewer, or alternative steps performed in similar or alternative orders, or in parallel, within the scope of the various embodiments unless otherwise stated.

At block 602, the example method 600 can present a first interface that provides a first set of content items. At block 604, the example method 600 can detect a command to present a second interface that provides a second set of content items. At block 606, the example method 600 can perform an animation that transitions from the first interface to the second interface. The animation can cause a second subset of content items out of the second set to be visually representative of a first subset of content items out of the first set.

FIG. 6B illustrates an example method 650 associated with providing transitions between content interfaces, according to an embodiment of the present disclosure. Again, it should be appreciated that there can be additional, fewer, or alternative steps performed in similar or alternative orders, or in parallel, within the scope of the various embodiments unless otherwise stated.

At block 652, the example method 650 can detect, subsequent to presenting the first interface, a trigger to load information associated with the second interface. At block 654, the example method 650 can initiate, prior to detecting the command to present the second interface, a loading of the information associated with the second interface. At block 656, the example method 650 can construct, prior to performing the animation, the second interface that provides the second set of content items. The second interface can be constructed based on the information.

It is contemplated that there can be many other uses, applications, features, possibilities, and/or variations associated with the various embodiments of the present disclosure. For example, in some instances, the disclosed technology can be applied to any user interfaces or portions thereof. In some embodiments, the first interface can be zoomed out or shrunk in order to present various other interfaces together. Moreover, in some cases, users can choose whether or not to opt-in to utilize the disclosed technology. The disclosed technology can, for instance, also ensure that various privacy settings and preferences are maintained and can prevent private information from being divulged. In another example, various embodiments of the present disclosure can learn, improve, and/or be refined over time.

### Social Networking System—Example Implementation

FIG. 7 illustrates a network diagram of an example system 700 that can be utilized in various scenarios, in accordance with an embodiment of the present disclosure. The system 700 includes one or more user devices 710, one or more external systems 720, a social networking system (or service) 730, and a network 750. In an embodiment, the social networking service, provider, and/or system discussed in connection with the embodiments described above may be implemented as the social networking system 730. For purposes of illustration, the embodiment of the system 700, shown by FIG. 7, includes a single external system 720 and a single user device 710. However, in other embodiments, the system 700 may include more user devices 710 and/or more external systems 720. In certain embodiments, the social networking system 730 is operated by a social network provider, whereas the external systems 720 are separate from the social networking system 730 in that they may be operated by different entities. In various embodiments, however, the social networking system 730 and the external systems 720 operate in conjunction to provide social networking services to users (or members) of the social networking system 730. In this sense, the social networking system 730 provides a platform or backbone, which other systems, such as external systems 720, may use to provide social networking services and functionalities to users across the Internet.

The user device 710 comprises one or more computing devices (or systems) that can receive input from a user and transmit and receive data via the network 750. In one embodiment, the user device 710 is a conventional computer system executing, for example, a Microsoft Windows compatible operating system (OS), Apple OS X, and/or a Linux distribution. In another embodiment, the user device 710 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 710 is configured to communicate via the network 750. The user device 710 can execute an application, for example, a browser application that allows a user of the user device 710 to interact with the social networking system 730. In another embodiment, the user device 710 interacts with the social networking system 730 through an application programming interface (API) provided by the native operating system of the user device 710, such as iOS and ANDROID. The user device 710 is configured to communicate with the external system 720 and the social networking system 730 via the network 750, which may comprise any combination of local area and/or wide area networks, using wired and/or wireless communication systems.

In one embodiment, the network 750 uses standard communications technologies and protocols. Thus, the network 750 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 750 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 750 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 710 may display content from the external system 720 and/or from the social networking system 730 by processing a markup language document 714 received from the external system 720 and from the social networking system 730 using a browser application 712. The markup language document 714 identifies content and one or more instructions describing formatting or presentation of the content. By executing the instructions included in the markup language document 714, the browser application 712 displays the identified content using the format or presentation described by the markup language document 714. For example, the markup language document 714 includes instructions for generating and displaying a web page having multiple frames that include text and/or image data retrieved from the external system 720 and the social networking system 730. In various embodiments, the markup language document 714 comprises a data file including extensible markup language (XML) data, extensible hypertext markup language (XHTML) data, or other markup language data. Additionally, the markup language document 714 may include JavaScript Object Notation (JSON) data, JSON with padding (JSONP), and JavaScript data to facilitate data-interchange between the external system 720 and the user device 710. The browser application 712 on the user device 710 may use a JavaScript compiler to decode the markup language document 714.

The markup language document 714 may also include, or link to, applications or application frameworks such as FLASH™ or Unity™ applications, the Silverlight™ application framework, etc.

In one embodiment, the user device 710 also includes one or more cookies 716 including data indicating whether a user of the user device 710 is logged into the social networking system 730, which may enable modification of the data communicated from the social networking system 730 to the user device 710.

The external system 720 includes one or more web servers that include one or more web pages 722a, 722b, which are communicated to the user device 710 using the network 750. The external system 720 is separate from the social networking system 730. For example, the external system 720 is associated with a first domain, while the social networking system 730 is associated with a separate social networking domain. Web pages 722a, 722b, included in the external system 720, comprise markup language documents 714 identifying content and including instructions specifying formatting or presentation of the identified content.

The social networking system 730 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 730 may be administered, managed, or controlled by an operator. The operator of the social networking system 730 may be a human being, an automated application, or a series of applications for managing content, regulating policies, and collecting usage metrics within the social networking system 730. Any type of operator may be used.

Users may join the social networking system 730 and then add connections to any number of other users of the social networking system 730 to whom they desire to be connected. As used herein, the term “friend” refers to any other user of the social networking system 730 to whom a user has formed a connection, association, or relationship via the social networking system 730. For example, in an embodiment, if users in the social networking system 730 are represented as nodes in the social graph, the term “friend” can refer to an edge formed between and directly connecting two user nodes.

Connections may be added explicitly by a user or may be automatically created by the social networking system 730 based on common characteristics of the users (e.g., users who are alumni of the same educational institution). For example, a first user specifically selects a particular other user to be a friend. Connections in the social networking system 730 are usually in both directions, but need not be, so the terms “user” and “friend” depend on the frame of reference. Connections between users of the social networking system 730 are usually bilateral (“two-way”), or “mutual,” but connections may also be unilateral, or “one-way.” For example, if Bob and Joe are both users of the social networking system 730 and connected to each other, Bob and Joe are each other's connections. If, on the other hand, Bob wishes to connect to Joe to view data communicated to the social networking system 730 by Joe, but Joe does not wish to form a mutual connection, a unilateral connection may be established. The connection between users may be a direct connection; however, some embodiments of the social networking system 730 allow the connection to be indirect via one or more levels of connections or degrees of separation.

In addition to establishing and maintaining connections between users and allowing interactions between users, the social networking system 730 provides users with the ability to take actions on various types of items supported by the social networking system 730. These items may include groups or networks (i.e., social networks of people, entities, and concepts) to which users of the social networking system 730 may belong, events or calendar entries in which a user might be interested, computer-based applications that a user may use via the social networking system 730, transactions that allow users to buy or sell items via services provided by or through the social networking system 730, and interactions with advertisements that a user may perform on or off the social networking system 730. These are just a few examples of the items upon which a user may act on the social networking system 730, and many others are possible. A user may interact with anything that is capable of being represented in the social networking system 730 or in the external system 720, separate from the social networking system 730, or coupled to the social networking system 730 via the network 750.

The social networking system 730 is also capable of linking a variety of entities. For example, the social networking system 730 enables users to interact with each other as well as external systems 720 or other entities through an API, a web service, or other communication channels. The social networking system 730 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 730. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 730 modifies edges connecting the various nodes to reflect the relationships and interactions.

The social networking system 730 also includes user-generated content, which enhances a user's interactions with the social networking system 730. User-generated content may include anything a user can add, upload, send, or “post” to the social networking system 730. For example, a user communicates posts to the social networking system 730 from a user device 710. Posts may include data such as status updates or other textual data, location information, images such as photos, videos, links, music or other similar data and/or media. Content may also be added to the social networking system 730 by a third party. Content “items” are represented as objects in the social networking system 730. In this way, users of the social networking system 730 are encouraged to communicate with each other by posting text and content items of various types of media through various communication channels. Such communication increases the interaction of users with each other and increases the frequency with which users interact with the social networking system 730.

The social networking system 730 includes a web server 732, an API request server 734, a user profile store 736, a connection store 738, an action logger 740, an activity log 742, and an authorization server 744. In an embodiment of the invention, the social networking system 730 may include additional, fewer, or different components for various applications. Other components, such as network interfaces, security mechanisms, load balancers, failover servers, management and network operations consoles, and the like are not shown so as to not obscure the details of the system.

The user profile store 736 maintains information about user accounts, including biographic, demographic, and other types of descriptive information, such as work experience, educational history, hobbies or preferences, location, and the like that has been declared by users or inferred by the social networking system 730. This information is stored in the user profile store 736 such that each user is uniquely identified. The social networking system 730 also stores data describing one or more connections between different users in the connection store 738. The connection information may indicate users who have similar or common work experience, group memberships, hobbies, or educational history. Additionally, the social networking system 730 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 730, such as non-person entities, buckets, cluster centers, images, interests, pages, external systems, concepts, and the like are also stored in the connection store 738.

The social networking system 730 maintains data about objects with which a user may interact. To maintain this data, the user profile store 736 and the connection store 738 store instances of the corresponding type of objects maintained by the social networking system 730. Each object type has information fields that are suitable for storing information appropriate to the type of object. For example, the user profile store 736 contains data structures with fields suitable for describing a user's account and information related to a user's account. When a new object of a particular type is created, the social networking system 730 initializes a new data structure of the corresponding type, assigns a unique object identifier to it, and begins to add data to the object as needed. This might occur, for example, when a user becomes a user of the social networking system 730, the social networking system 730 generates a new instance of a user profile in the user profile store 736, assigns a unique identifier to the user account, and begins to populate the fields of the user account with information provided by the user.

The connection store 738 includes data structures suitable for describing a user's connections to other users, connections to external systems 720 or connections to other entities. The connection store 738 may also associate a connection type with a user's connections, which may be used in conjunction with the user's privacy setting to regulate access to information about the user. In an embodiment of the invention, the user profile store 736 and the connection store 738 may be implemented as a federated database.

Data stored in the connection store 738, the user profile store 736, and the activity log 742 enables the social networking system 730 to generate the social graph that uses nodes to identify various objects and edges connecting nodes to identify relationships between different objects. For example, if a first user establishes a connection with a second user in the social networking system 730, user accounts of the first user and the second user from the user profile store 736 may act as nodes in the social graph. The connection between the first user and the second user stored by the connection store 738 is an edge between the nodes associated with the first user and the second user. Continuing this example, the second user may then send the first user a message within the social networking system 730. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 730 (or, alternatively, in an image maintained by another system outside of the social networking system 730). The image may itself be represented as a node in the social networking system 730. This tagging action may create edges between the first user and the second user as well as create an edge between each of the users and the image, which is also a node in the social graph. In yet another example, if a user confirms attending an event, the user and the event are nodes obtained from the user profile store 736, where the attendance of the event is an edge between the nodes that may be retrieved from the activity log 742. By generating and maintaining the social graph, the social networking system 730 includes data describing many different types of objects and the interactions and connections among those objects, providing a rich source of socially relevant information.

The web server 732 links the social networking system 730 to one or more user devices 710 and/or one or more external systems 720 via the network 750. The web server 732 serves web pages, as well as other web-related content, such as Java, JavaScript, Flash, XML, and so forth. The web server 732 may include a mail server or other messaging functionality for receiving and routing messages between the social networking system 730 and one or more user devices 710. The messages can be instant messages, queued messages (e.g., email), text and SMS messages, or any other suitable messaging format.

The API request server 734 allows one or more external systems 720 and user devices 710 to call access information from the social networking system 730 by calling one or more API functions. The API request server 734 may also allow external systems 720 to send information to the social networking system 730 by calling APIs. The external system 720, in one embodiment, sends an API request to the social networking system 730 via the network 750, and the API request server 734 receives the API request. The API request server 734 processes the request by calling an API associated with the API request to generate an appropriate response, which the API request server 734 communicates to the external system 720 via the network 750. For example, responsive to an API request, the API request server 734 collects data associated with a user, such as the user's connections that have logged into the external system 720, and communicates the collected data to the external system 720. In another embodiment, the user device 710 communicates with the social networking system 730 via APIs in the same manner as external systems 720.

The action logger 740 is capable of receiving communications from the web server 732 about user actions on and/or off the social networking system 730. The action logger 740 populates the activity log 742 with information about user actions, enabling the social networking system 730 to discover various actions taken by its users within the social networking system 730 and outside of the social networking system 730. Any action that a particular user takes with respect to another node on the social networking system 730 may be associated with each user's account, through information maintained in the activity log 742 or in a similar database or other data repository. Examples of actions taken by a user within the social networking system 730 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 730, the action is recorded in the activity log 742. In one embodiment, the social networking system 730 maintains the activity log 742 as a database of entries. When an action is taken within the social networking system 730, an entry for the action is added to the activity log 742. The activity log 742 may be referred to as an action log.

Additionally, user actions may be associated with concepts and actions that occur within an entity outside of the social networking system 730, such as an external system 720 that is separate from the social networking system 730. For example, the action logger 740 may receive data describing a user's interaction with an external system 720 from the web server 732. In this example, the external system 720 reports a user's interaction according to structured actions and objects in the social graph.

Other examples of actions where a user interacts with an external system 720 include a user expressing an interest in an external system 720 or another entity, a user posting a comment to the social networking system 730 that discusses an external system 720 or a web page 722a within the external system 720, a user posting to the social networking system 730 a Uniform Resource Locator (URL) or other identifier associated with an external system 720, a user attending an event associated with an external system 720, or any other action by a user that is related to an external system 720. Thus, the activity log 742 may include actions describing interactions between a user of the social networking system 730 and an external system 720 that is separate from the social networking system 730.

The authorization server 744 enforces one or more privacy settings of the users of the social networking system 730. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 720, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 720. One embodiment allows the specification of the set of entities to comprise an enumeration of entities. For example, the user may provide a list of external systems 720 that are allowed to access certain information. Another embodiment allows the specification to comprise a set of entities along with exceptions that are not allowed to access the information. For example, a user may allow all external systems 720 to access the user's work information, but specify a list of external systems 720 that are not allowed to access the work information. Certain embodiments call the list of exceptions that are not allowed to access certain information a “block list”. External systems 720 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 744 contains logic to determine if certain information associated with a user can be accessed by a user's friends, external systems 720, and/or other applications and entities. The external system 720 may need authorization from the authorization server 744 to access the user's more private and sensitive information, such as the user's work phone number. Based on the user's privacy settings, the authorization server 744 determines if another user, the external system 720, an application, or another entity is allowed to access information associated with the user, including information about actions taken by the user.

In some embodiments, the user device 710 can include an interface transition module 718. The interface transition module 718 can, for example, be implemented as the interface transition module 102 of FIG. 1. As discussed previously, it should be appreciated that there can be many variations or other possibilities. For example, in some instances, the interface transition module 718 (or at least a portion thereof) can be included in the social networking system 730. Other features of the interface transition module 718 are discussed herein in connection with the interface transition module 102.

### Hardware Implementation

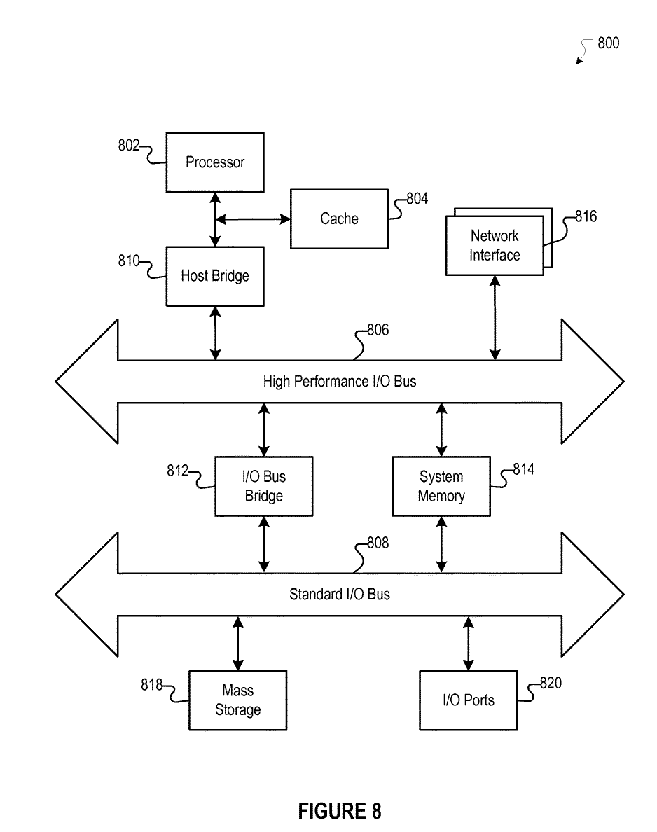

The foregoing processes and features can be implemented by a wide variety of machine and computer system architectures and in a wide variety of network and computing environments. FIG. 8 illustrates an example of a computer system 800 that may be used to implement one or more of the embodiments described herein in accordance with an embodiment of the invention. The computer system 800 includes sets of instructions for causing the computer system 800 to perform the processes and features discussed herein. The computer system 800 may be connected (e.g., networked) to other machines. In a networked deployment, the computer system 800 may operate in the capacity of a server machine or a client machine in a client-server network environment, or as a peer machine in a peer-to-peer (or distributed) network environment. In an embodiment of the invention, the computer system 800 may be the social networking system 730, the user device 710, and the external system 820, or a component thereof. In an embodiment of the invention, the computer system 800 may be one server among many that constitutes all or part of the social networking system 730.

The computer system 800 includes a processor 802, a cache 804, and one or more executable modules and drivers, stored on a computer-readable medium, directed to the processes and features described herein. Additionally, the computer system 800 includes a high performance input/output (I/O) bus 806 and a standard I/O bus 808. A host bridge 810 couples processor 802 to high performance I/O bus 806, whereas I/O bus bridge 812 couples the two buses 806 and 808 to each other. A system memory 814 and one or more network interfaces 816 couple to high performance I/O bus 806. The computer system 800 may further include video memory and a display device coupled to the video memory (not shown). Mass storage 818 and I/O ports 820 couple to the standard I/O bus 808. The computer system 800 may optionally include a keyboard and pointing device, a display device, or other input/output devices (not shown) coupled to the standard I/O bus 808. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 800, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 800 are described in greater detail below. In particular, the network interface 816 provides communication between the computer system 800 and any of a wide range of networks, such as an Ethernet (e.g., IEEE 802.3) network, a backplane, etc. The mass storage 818 provides permanent storage for the data and programming instructions to perform the above-described processes and features implemented by the respective computing systems identified above, whereas the system memory 814 (e.g., DRAM) provides temporary storage for the data and programming instructions when executed by the processor 802. The I/O ports 820 may be one or more serial and/or parallel communication ports that provide communication between additional peripheral devices, which may be coupled to the computer system 800.

The computer system 800 may include a variety of system architectures, and various components of the computer system 800 may be rearranged. For example, the cache 804 may be on-chip with processor 802. Alternatively, the cache 804 and the processor 802 may be packed together as a “processor module”, with processor 802 being referred to as the “processor core”. Furthermore, certain embodiments of the invention may neither require nor include all of the above components. For example, peripheral devices coupled to the standard I/O bus 808 may couple to the high performance I/O bus 806. In addition, in some embodiments, only a single bus may exist, with the components of the computer system 800 being coupled to the single bus. Moreover, the computer system 800 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 800 that, when read and executed by one or more processors, cause the computer system 800 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 800, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 802. Initially, the series of instructions may be stored on a storage device, such as the mass storage 818. However, the series of instructions can be stored on any suitable computer readable storage medium. Furthermore, the series of instructions need not be stored locally, and could be received from a remote storage device, such as a server on a network, via the network interface 816. The instructions are copied from the storage device, such as the mass storage 818, into the system memory 814 and then accessed and executed by the processor 802. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 800 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments. Furthermore, reference in this specification to “based on” can mean “based, at least in part, on”, “based on at least a portion/part of”, “at least a portion/part of which is based on”, and/or any combination thereof.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
presenting a first interface that provides a first set of content items;
detecting a command to present a second interface that provides a second set of content items; and
performing an animation that transitions from the first interface to the second interface, the animation causing a second subset of content items out of the second set to be visually representative of a first subset of content items out of the first set.

2. The computer-implemented method of claim 1, further comprising:
detecting, subsequent to presenting the first interface, a trigger to load information associated with the second interface;
initiating, prior to detecting the command to present the second interface, a loading of the information associated with the second interface; and
constructing, prior to performing the animation, the second interface that provides the second set of content items, the second interface being constructed based on the information.

3. The computer-implemented method of claim 2, wherein the trigger occurs when a specified minimum amount of time has elapsed while the first interface is presented.

4. The computer-implemented method of claim 2, wherein at least some content items in the second set are provided based on the information.

5. The computer-implemented method of claim 1, wherein at least some content items in the second subset are provided based on at least some content items in the first subset.

6. The computer-implemented method of claim 5, wherein the at least some content items in the first subset include at least one of a profile image, a cover image, or an entity identifier.

7. The computer-implemented method of claim 1, further comprising:
providing access to at least a third interface adjacent to the first interface along a first axis, wherein the second interface is accessible from the first interface via a second axis.

8. The computer-implemented method of claim 7, wherein the first axis includes a horizontal axis and the second axis includes a vertical axis, and wherein access to at least the third interface is provided based on a first scroll command performed with respect to the horizontal axis, and wherein the command to present the second interface includes a second scroll command performed with respect to the vertical axis.

9. The computer-implemented method of claim 8, wherein each of the first scroll command and the second scroll command is associated with at least one of a mouse click operation, a mouse drag operation, a mouse hover operation, a tapping touch gesture, a holding touch gesture, or a swiping touch gesture.

10. The computer-implemented method of claim 1, wherein the animation causes a first planar size of the first interface to be visually matched, within an allowable deviation, with a second planar size of the second interface, wherein the animation includes cross-fading between the first interface and the second interface, and wherein the animation includes scrolling from the first interface to the second interface at a smooth scrolling pace.

11. A system comprising:
at least one processor; and
a memory storing instructions that, when executed by the at least one processor, cause the system to perform:
presenting a first interface that provides a first set of content items;
detecting a command to present a second interface that provides a second set of content items; and
performing an animation that transitions from the first interface to the second interface, the animation causing a second subset of content items out of the second set to be visually representative of a first subset of content items out of the first set.

12. The system of claim 11, wherein the instructions cause the system to further perform:
detecting, subsequent to presenting the first interface, a trigger to load information associated with the second interface;
initiating, prior to detecting the command to present the second interface, a loading of the information associated with the second interface; and
constructing, prior to performing the animation, the second interface that provides the second set of content items, the second interface being constructed based on the information.

13. The system of claim 11, wherein the instructions cause the system to further perform:
providing access to at least a third interface adjacent to the first interface along a first axis, wherein the second interface is accessible from the first interface via a second axis.

14. The system of claim 13, wherein the first axis includes a horizontal axis and the second axis includes a vertical axis, and wherein access to at least the third interface is provided based on a first scroll command performed with respect to the horizontal axis, and wherein the command to present the second interface includes a second scroll command performed with respect to the vertical axis.

15. The system of claim 11, wherein the animation causes a first planar size of the first interface to be visually matched, within an allowable deviation, with a second planar size of the second interface, wherein the animation includes cross-fading between the first interface and the second interface, and wherein the animation includes scrolling from the first interface to the second interface at a smooth scrolling pace.

16. A non-transitory computer-readable storage medium including instructions that, when executed by at least one processor of a computing system, cause the computing system to perform a method comprising:
presenting a first interface that provides a first set of content items;
detecting a command to present a second interface that provides a second set of content items; and
performing an animation that transitions from the first interface to the second interface, the animation causing a second subset of content items out of the second set to be visually representative of a first subset of content items out of the first set.

17. The non-transitory computer-readable storage medium of claim 16, wherein the instructions cause the computing system to further perform:
detecting, subsequent to presenting the first interface, a trigger to load information associated with the second interface;
initiating, prior to detecting the command to present the second interface, a loading of the information associated with the second interface; and
constructing, prior to performing the animation, the second interface that provides the second set of content items, the second interface being constructed based on the information.

18. The non-transitory computer-readable storage medium of claim 16, wherein the instructions cause the computing system to further perform:
providing access to at least a third interface adjacent to the first interface along a first axis, wherein the second interface is accessible from the first interface via a second axis.

19. The non-transitory computer-readable storage medium of claim 18, wherein the first axis includes a horizontal axis and the second axis includes a vertical axis, and wherein access to at least the third interface is provided based on a first scroll command performed with respect to the horizontal axis, and wherein the command to present the second interface includes a second scroll command performed with respect to the vertical axis.

20. The non-transitory computer-readable storage medium of claim 16, wherein the animation causes a first planar size of the first interface to be visually matched, within an allowable deviation, with a second planar size of the second interface, wherein the animation includes cross-fading between the first interface and the second interface, and wherein the animation includes scrolling from the first interface to the second interface at a smooth scrolling pace.
